(19) United States
(12) Patent Application Publication
(10) Pub. No.: US 2004/0084237 A1
(43) Pub. Date: May 6, 2004

(54) Vehicle cruise control system

(76) Inventor: Alfred E. Petrie JR., Menasha, WI (US)

Correspondence Address: WILHELM LAW SERVICE, S.C., 100 W LAWRENCE ST, THIRD FLOOR, APPLETON, WI, 54911

(21) Appl. No.: 10/693,293

(22) Filed: Oct. 24, 2003

Related U.S. Application Data
(63) Continuation-in-part of application No. 10/157,528, filed on May 30, 2002, now abandoned.

(51) Int. Cl. B60K 31/00

(52) U.S. Cl. 180/170

(57) ABSTRACT

A cruise control systems for regulating vehicle speed comprises a system controller, a speed sensor, a fuel controller, and a driver interface. An operator of such cruise control system can input an upper set speed, and a lower set speed, individually or combined so as to define an allowable vehicle speed range. Accordingly, an operator of such cruise control system can modify the operating parameters of the cruise control system to correspond with the operators driving needs. An operator can define a relatively wide allowable speed range in the interest of fuel economy; alternatively an operator can define a relatively narrow allowable speed range in the interest of vehicle travel speed consistency.

### CROSS-REFERENCE TO RELATED APPLICATIONS

This application is a Continuation-in-Part application claiming priority under 35 U.S.C. 120 to U.S. application Ser. No. 10/157,528, filed May 30, 2002, the entirety of which is incorporated by reference.

### BACKGROUND

The present invention relates to a device for regulating vehicle speed. Such devices are commonly known as vehicle cruise control systems, and are generally available for a wide variety of vehicles, including commercial vehicles and noncommercial vehicles. Typical commercial vehicles include heavy working trucks such as dump trucks, and tractor trucks for pulling e.g. semi trailers, as well as others. Typical non-commercial vehicles include passenger vehicles, light duty trucks, and motorcycles, as well as others.

As is know in the art, a conventional vehicle cruise control system allows a vehicle operator, such as a driver, to select a vehicle set speed to be maintained. The conventional vehicle cruise control system monitors actual vehicle speed in relation to the set speed. In accordance with such monitoring, the vehicle cruise control system attempts to maintain the set speed by abating or otherwise limiting the deviation between the vehicle speed and the set speed. Specifically, a conventional cruise control system detects deviation from a set speed, and reacts to reduce or eliminate the deviation.

In a typical vehicle powered by an internal combustion engine, the speed regulation is effectuated by regulating fuel flow to the internal combustion engine. Thus, if the vehicle cruise control system detects an under-speed condition as a deviation, the vehicle cruise control system commands an increase in fuel flow.

As the amount of torque an internal combustion engine produces is roughly proportional to the amount of fuel provided to the internal combustion engine, increased fuel flow will typically increase driving torque of the drive train, and correspondingly tends to increase vehicle speed, thereby to diminish the deviation between actual vehicle speed and the set speed.

Alternatively, if the vehicle cruise control system detects an over-speed deviation condition, the vehicle cruise control system commands a decrease in fuel flow. As the amount of fuel provided to the internal combustion engine is decreased, so will there be a reduction in the torque produced by the internal combustion engine. Accordingly, vehicle speed will typically decrease and correspondingly diminish the deviation between actual vehicle speed and the set speed.

Conventional vehicle cruise control systems typically have features, which enable the user to adjust the vehicle set speed during operation of the vehicle cruise control system. For example, a user is able to use a conventional vehicle cruise control acceleration function to cause the vehicle, which is already operating at a first set speed to accelerate to a desired new set speed, thereby designating the new, higher speed as the set speed. Alternatively, the user is able to use a conventional vehicle cruise control coast/decelerate function to cause the vehicle, which is already operating at a first set speed to decelerate to a desired new set speed, thereby designating the new, lower speed as the set speed.

Conventional cruise control systems provide the user with essentially no means to manage the operational parameters of the vehicle cruise control system other than the set speed. A user of a conventional vehicle cruise control system typically selects a set speed, and the vehicle cruise control system operates according to operational criteria which are designed, built, and fixed in the cruise control system.

It is an object of the invention to provide a vehicle cruise control system which enables a driver to set at least one of an upper set speed, and a lower set speed independently of the target set speed.

It is a further object of the invention to provide a vehicle cruise control system which enables a driver to set a target set speed, and further enables the driver to redefine at least one of the upper set speed and the lower set speed.

Yet a further object of the invention is to provide a vehicle cruise control system which enables a driver to define a speed range between an upper set speed and a lower set speed, and further enables the driver to redefine at least one of the upper set speed and lower set speed, so as to redefine the speed range.

Still a further object of the invention is to provide a vehicle cruise control system which enables a driver to define, and redefine, a target speed within a given speed range.

Another object of the invention is to provide a vehicle cruise control system which enables a driver to define an upper set speed and/or a lower speed as fixed quantities in relation to a target set speed.

Yet another object of the invention is to provide a vehicle cruise control system which enables a driver to define an upper set speed and/or a lower set speed as percentage variations from a target set speed, whereby the absolute variation quantities change as the target set speed is changed.

### SUMMARY

Cruise control systems of the invention, for regulating vehicle speed, comprise a system controller, a speed sensor, a fuel controller, and a user interface. A user, such as an operator of such cruise control system can input as operating parameters, in addition to a target set speed, an upper set speed and a lower set speed, individually or in combination so as to define an allowable vehicle speed range, which includes the target set speed. Accordingly, an operator of such cruise control system can modify the operating parameters of the cruise control system to correspond with the operator's driving needs. For example, an operator can define a relatively wide allowable speed range in the interest of fuel economy; alternatively an operator can define a relatively narrow allowable speed range in the interest of vehicle travel speed consistency. Preferably, a user is able to define/redefine any one or more of upper set speed, target set speed, and lower set speed, independent of any of the others, especially while the cruise control system is in operational use.

In a first family of embodiments, the invention comprehends a vehicle cruise control system. The cruise control system comprises a system controller adapted to process information and to establish a cruise control speed range defined by an upper set speed and a lower set speed, a target set speed being defined in such speed range, the system controller comprising a processor, and being adapted to generate and send a command; a speed sensor adapted to sense vehicle speed and to communicate vehicle speed information to the system controller; a fuel controller adapted to sense fuel flow information, and to communicate fuel flow information to the system controller, the fuel controller being further adapted to receive a command from the system controller, and to execute an action corresponding to such command; and a driver interface adapted to receive driver input and to communicate such driver input to the system controller, such driver input including at least one of a driver determined such upper set speed, and a driver determined such lower set speed, wherein at least one of the upper set speed and the lower set speed can be selected by such driver independent of the target set speed.

In some embodiments, the command is generated in response to the vehicle speed being proximate the lower set speed, the command comprising an instruction communicated to the fuel controller to change fuel flow rate so as to attenuate loss of vehicle speed.

In some embodiments, the command comprises commanding a decrease in fuel flow rate as the vehicle speed approaches, and prior to the vehicle speed reaching, the target set speed from the lower set speed.

In some embodiments, the command is generated in response to the vehicle speed being proximate the upper set speed, the command comprising an instruction communicated to the fuel controller to change fuel flow rate so as to attenuate increase in vehicle speed.

In some embodiments, the driver input comprises a driver selected upper speed, a driver selected lower speed, and a driver selected target speed.

In some embodiments, the command further comprises commanding an increase in real time fuel flow rate as the vehicle speed approaches, and prior to the vehicle speed reaching, the target set speed from the upper set speed.

In some embodiments, the fuel flow controller generally maintains a constant fuel flow rate corresponding to the fuel flow rate corresponding to the target set speed while the vehicle speed changes away from the target set speed, wherein the processor of the system controller generates the command when vehicle speed approximates the upper set speed, or vehicle speed approximates the lower set speed.

In some embodiments, the command is generated in response to the vehicle speed being proximate the lower set speed, the command comprising an instruction communicated to the fuel controller to change fuel flow rate so as to attenuate loss of vehicle speed.

In some embodiments, the command further comprises commanding a decrease in real time fuel flow rate as the vehicle speed approaches, and prior to the vehicle speed reaching, the target set speed from the lower set speed.

In preferred embodiments the command further comprises commanding an exponential decrease in the change in fuel flow rate, from the real time fuel flow rate, toward the fuel flow rate corresponding to the target set speed.

In yet other embodiments, the command is generated in response to the vehicle speed being proximate the upper set speed, the command comprising an instruction communicated to the fuel controller to change real time fuel flow rate so as to attenuate increase in vehicle speed.

In some embodiments, the cruise control system is adapted to receive and implement ongoing driver inputs changing any of the upper set speed, the lower set speed, and the target set speed, while the vehicle cruise control system is in operation controlling speed of a vehicle.

In some embodiments, the system controller is further adapted to process vehicle speed, and analyze changes in vehicle speed versus time to thereby compute acceleration, the system controller being adapted to analyze any combination of acceleration, vehicle speed, fuel flow rate, and driver input to generate such command.

In some embodiments, the system controller generates the command when absolute acceleration of the vehicle exceeds a predetermined acceleration rate threshold, and wherein the command comprises commanding a corresponding change in fuel flow rate based, at least in part, on the acceleration rate.

In some embodiments, the vehicle cruise control system maintains the lower set speed, or the upper set speed, for a predetermined time period, whereupon the system controller subsequently commands the fuel controller to change real time fuel flow rate so as to change vehicle speed to a speed closer to the target speed.

In some embodiments, the input includes defining a driver anticipated stop, the system controller commanding the fuel controller to reduce fuel flow, thereby accommodating such driver anticipated stop and saving total quantity of fuel used during the stopping process.

In some embodiments, the cruise control system is further adapted to define a real time base fuel flow rate corresponding to the target set speed and to compare such real time base fuel flow rate to a pre-determined base fuel flow rate for the target set speed, stored in a database, establishing a base fuel flow rate deviation between real time fuel flow rate and the pre-determined base fuel flow rate, and wherein the system controller sends such real time fuel flow rate information to the database and/or generates and sends a command to the fuel controller.

In some embodiments, the command is generated in response to the fuel flow rate deviation exceeding a predetermined value.

In some embodiments, the fuel flow rate deviation exceeds a predetermined value and vehicle speed approaches one of the lower set speed and the upper set speed, subsequently the vehicle cruise control system maintains one of the vehicle speed or the real time fuel flow rate for a predetermined time period, subsequently the system controller commands the fuel controller to change real time fuel flow rate so as to bring vehicle speed closer to the target set speed.

In some embodiments, the real time base fuel flow rate is compared to data in the database, and the system controller generates the command based on such comparison.

The invention further comprehends a vehicle comprising a cruise control system of the current invention.

In a second family of embodiments, the invention contemplates a vehicle cruise control system. The cruise control system comprises a system controller adapted to process information, the system controller comprising a processor, and being adapted to generate and send a command; a speed sensor adapted to sense vehicle speed and to communicate vehicle speed information to the system controller; a fuel controller adapted to sense fuel flow information, and to communicate fuel flow information to the system controller, the fuel controller being further adapted to receive a command from the system controller, and to execute an action corresponding to such command; and a driver interface adapted to receive driver input and to communicate such driver input to the system controller, such driver input including a driver determined upper set speed, and a driver determined lower set speed, the processor being adapted to select an initial default target set speed between the upper set speed and the lower set speed, the system controller being adapted to process vehicle speed, fuel flow, and driver input to generate a command, the system controller being adapted to communicate such command to the fuel controller.

In some embodiments, the processor of the system controller generates the command when vehicle speed approximates the driver selected upper set speed, or vehicle speed approximates the driver selected lower set speed, and wherein speeds between the upper set speed and the lower set speed generally define a desired operating speed range.

In a third family of embodiments, the invention comprehends a vehicle cruise control system. The cruise control system comprises a system controller adapted to process information, the system controller comprising a processor, and being adapted to generate and send a command; a speed sensor adapted to sense vehicle speed and to communicate vehicle speed information to the system controller; a fuel controller adapted to sense fuel flow information, and to communicate fuel flow information to the system controller, the fuel controller being further adapted to receive a command from the system controller, and to execute an action corresponding to such command; and a driver interface adapted to receive driver input and to communicate such driver input to the system controller, such driver input including a driver selected target set speed, and a plurality of driver selectable terrain types, each of the driver selectable terrain types having a predetermined upper set speed and a predetermined lower set speed, relative to the target set speed, corresponding to the driver selectable target set speed, the processor being adapted to process the vehicle speed, the fuel flow rate, and the driver input to generate a command, the system controller being adapted to communicate such command to the fuel controller.

In a fourth family of embodiments, the invention comprehends a vehicle cruise control system. The cruise control system comprises a system controller adapted to process information, the system controller comprising a processor, and being adapted to generate and send a command; a speed sensor adapted to sense vehicle speed and to communicate vehicle speed information to the system controller; a fuel controller adapted to sense fuel flow information, and to communicate fuel flow information to the system controller, the fuel controller being further adapted to receive a command from the system controller, and to execute an action corresponding to such command; and a driver interface adapted to receive driver input and to communicate such driver input to the system controller, such driver input including a driver determined target set speed, the system controller providing at least one of an upper set speed and a lower set speed, the cruise control system being adapted to receive and implement ongoing driver redefinition of the upper set speed, the lower set speed, and/or the target set speed while the vehicle cruise control system is in operation controlling speed of a vehicle.

In some embodiments, the input includes defining a driver anticipated stop, the system controller commanding the fuel controller to reducing fuel flow, thereby accommodating such driver anticipated stop and saving total quantity of fuel used during the stopping process.

In a fifth family of embodiments, the invention comprehends a vehicle cruise control system. The cruise control system comprises a system controller adapted to process information, the system controller comprising a processor, and being adapted to generate and send a command; a speed sensor adapted to sense vehicle speed and to communicate vehicle speed information to the system controller; a fuel controller adapted to sense fuel flow information, and to communicate fuel flow information to the system controller, the fuel controller being further adapted to receive a command from the system controller, and to execute an action corresponding to such command; and a driver interface adapted to receive driver input and to communicate such driver input to the system controller, such driver input including at least one of an upper set speed and a lower set speed. The processor is adapted to select a target set speed, and the remaining one of the upper set speed and the lower set speed, consistent with the driver input, thereby to establish a target set speed, and a desired operating speed range between the upper set speed and the lower set speed.

In a sixth family of embodiments, the invention comprehends a method of controlling vehicle speed. The method comprises processing information in a system controller and establishing a cruise control speed range defined by an upper set speed and a lower set speed, a target set speed being defined in such speed range, sensing vehicle speed in a speed sensor and communicating vehicle speed information to the system controller; sensing fuel flow information in a fuel controller and communicating such fuel flow information from the fuel controller to the system controller, the fuel controller being further adapted to receive a command from the system controller, and to execute an action corresponding to such command; and receiving driver input in a driver interface and communicating such driver input to the system controller, such driver input including at least one of a driver selected such upper set speed, and a driver selected such lower set speed, wherein at least one of the upper set speed and the lower set speed can be selected by such driver independent of the target set speed.

In some embodiments, the method includes controlling vehicle speed, wherein the command is generated in response to the vehicle speed being proximate the lower set speed, the command comprising an instruction transmitted to the fuel controller to change fuel flow rate so as to attenuate loss of vehicle speed.

In some embodiments, the method includes controlling vehicle speed, wherein the command is generated in response to the vehicle speed being proximate the upper set speed, the command comprising an instruction transmitted to the fuel controller to change fuel flow rate so as to attenuate increase in vehicle speed.

In some embodiments, the method includes controlling vehicle speed, wherein the fuel flow controller generally maintains a constant fuel flow rate relative to the fuel flow rate corresponding to the target set speed, wherein the system controller generates the command when vehicle speed approximates the upper set speed, or vehicle speed approximates the lower set speed.

In some embodiments, the method includes controlling vehicle speed, wherein the command is generated in response to the vehicle speed being proximate the lower set speed, the command comprising an instruction transmitted to the fuel controller to change fuel flow rate so as to attenuate loss of vehicle speed.

In some embodiments, the method includes controlling vehicle speed, wherein the command is generated in response to the vehicle speed being proximate the upper set speed, the command comprising an instruction transmitted to the fuel controller to change real time fuel flow rate so as to attenuate increase in vehicle speed.

In a seventh family of embodiments, the invention comprehends a method of controlling vehicle speed. The method comprises processing information in a system controller being adapted to process information, generate a command, and send such command to a fuel controller; sensing vehicle speed in a speed sensor and communicating vehicle speed information to the system controller; sensing fuel flow information in the fuel controller and communicating such fuel flow information from the fuel controller to the system controller, the fuel controller being further adapted to receive a command from the system controller, and to execute an action corresponding to such command; and receiving driver input in a driver interface and communicating such driver input to the system controller, such driver input including a driver selected target set speed, the system controller providing at least one of an upper set speed and a lower set speed, the cruise control system being adapted to receive and implement ongoing redefinition of the upper set speed, the lower set speed, and/or the target set speed while the vehicle cruise control system is in operation controlling speed of a vehicle.

In some embodiments, the method includes controlling vehicle speed, wherein the command is generated in response to the vehicle speed being proximate the lower set speed, the command comprising an instruction transmitted to the fuel controller to change fuel flow rate so as to attenuate loss of vehicle speed.

In some embodiments, the method includes controlling vehicle speed, wherein the command is generated in response to the vehicle speed being proximate the upper set speed, the command comprising an instruction transmitted to the fuel controller to change fuel flow rate so as to attenuate increase in vehicle speed.

In some embodiments, the method includes controlling vehicle speed, wherein the fuel flow controller generally maintains a constant fuel flow rate relative to the fuel flow rate corresponding to the target set speed, wherein the system controller generates the command when vehicle speed approximates the upper set speed, or vehicle speed approximates the lower set speed.

In some embodiments, the method includes controlling vehicle speed, wherein the command is generated in response to the vehicle speed being proximate the lower set speed, the command comprising an instruction transmitted to the fuel controller to change fuel flow rate so as to attenuate loss of vehicle speed.

In some embodiments, the method includes controlling vehicle speed, wherein the command is generated in response to the vehicle speed being proximate the upper set speed, the command comprising an instruction transmitted to the fuel controller to change real time fuel flow rate so as to attenuate increase in vehicle speed.

### BRIEF DESCRIPTION OF THE DRAWINGS

FIG. 1 is a diagram illustrating the architecture of a vehicle cruise control systems of the invention

FIG. 2 is a diagram further illustrating, in more detail, the architecture of a driver interface used in the cruise control system of FIG. 1.

FIG. 3 is a diagram illustrating, in more detail, the architecture of a system controller, used in the cruise control system of FIG. 1.

The invention is not limited in its application to the details of construction or the arrangement of the components set forth in the following description or illustrated in the drawings. The invention is capable of other embodiments or of being practiced or carried out in other various ways. Also, it is to be understood that the terminology and phraseology employed herein is for purpose of description and illustration and should not be regarded as limiting. Like reference numerals are used to indicate like components.

### DESCRIPTION OF THE ILLUSTRATED EMBODIMENTS

### System Architecture

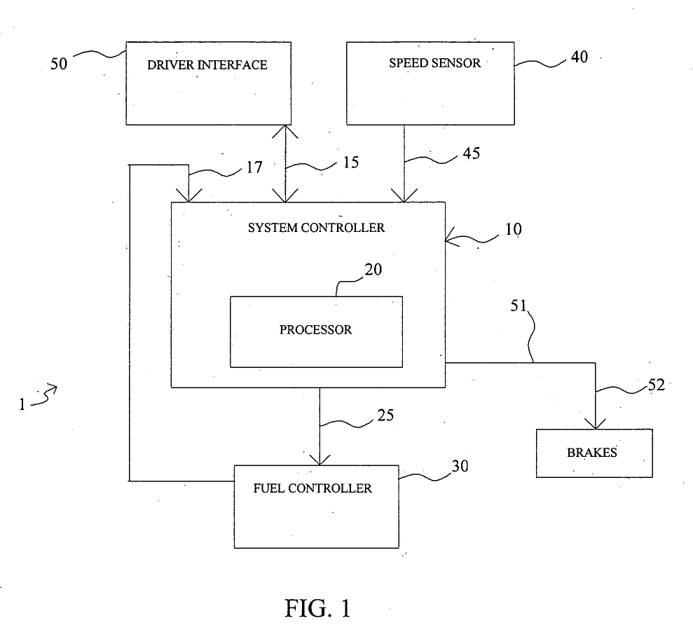

Referring now to the drawings, FIG. 1 shows, in diagram form, a first embodiment of vehicle cruise control systems of the invention. Cruise control system 1 includes a system controller 10, fuel controller 30, speed sensor 40, and driver interface 50. Individual ones of components 10, 30, 40, 50 of cruise control system 1 are capable of sending, receiving, transmitting, or otherwise relaying or communicating information. Driver interface 50 sends information 15 to system controller 10, while the system controller 10 also sends information 15 to driver/user interface 50. Fuel controller 30 sends information 17 to system controller 10. System controller 10 sends information 25 to fuel controller 30. Speed sensor 40 sends information 45 to system controller 10.

Cruise control system 1 can also send information to, and receive information from, vehicle components outside of cruise control system 1. Cruise control system 1 uses information 15, 17, 45 to analyze current vehicle operating conditions, and thereby to generate commands 25 accordingly, and to transmit commands 25 to, for example fuel controller 30. In some embodiments, information or commands 51 can be used to apply vehicle brakes 52. Command 25 instructs the fuel controller 30 to adjust fuel flow, thus changing the operating conditions, particularly fuel consumption, and accordingly speed, of the vehicle in accordance with command 25.

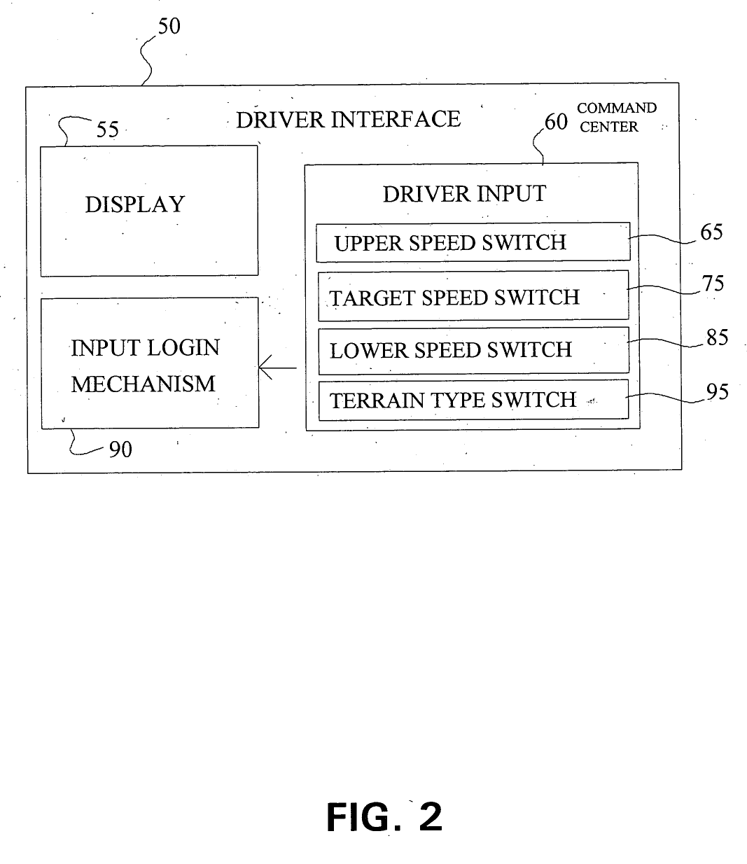

As shown in FIG. 2, driver interface 50 comprises a driver display 55, and an input mechanism 90. Driver interface 50 enables a driver to enter driver input at

command center 60 through an upper set speed switch 65, a target set speed switch 75, and a lower set speed switch 85.

In alternative embodiments, cruise control system 1 enables the driver to manipulate the target set speed switch 75, and a terrain type switch 95 thereby to select target set speed and terrain type. Based on the terrain type selected by the driver, and further based on the vehicle speed at the time the option is implemented, cruise control system 1 sets a default upper set speed, and a default lower set speed. In the terrain mode, the driver has the option to predefine the upper and lower default set speeds for each given terrain type, and to redefine any such default value.

In some embodiments, the user is able to select other characteristics, such as strength of headwind or tailwind, wherein each set speed option defines a default combination of upper set speed and lower set speed, and target set speed; the cruise control system enabling the user to define/redefine any such default value, together or independent of other ones of the default values.

Driver display 55 can be any apparatus conventionally used to relay information to an operator. For example, driver display 55 can comprise a visual display device, such as a digital display unit. In some embodiments, the digital display unit shows at least one of the driver input values. In some embodiments of the invention, the display illustrates upper set speed, target set speed, and lower set speed simultaneously, as well as optionally current vehicle speed. Such an embodiment would allow the user to visually appreciate the entire speed range, as well as visually recognize the relative values of target set speed, and real time vehicle speed, within the range.

In some embodiments, driver display 55 is integrated within another visual display device in the driver's vehicle information module, which displays e.g. speed related information, e.g. the vehicle speedometer. Driver display 55 can display cruise control set speed information at the vehicle speedometer, or on a speedometer scale, for easy reference. In other embodiments, driver display 55 displays information directly above and/or below the vehicle speedometer and/or is a color which contrasts with the color of the vehicle speedometer display. In some embodiments, driver display 55 displays information generally superimposed on the speedometer display information or superimposes the speedometer information on display 55; or integrates the cruise control information with the speedometer information. For example, indication marks corresponding to upper set speed, target set speed, and lower set speed appear directly on, or closely adjacent the vehicle speedometer scale.

In some embodiments, the visual representation of the speed range between the upper set speed and the lower set speed is represented in, e.g. a linear scale. Upper speed and lower speed are numerically represented, and a graphic depicting the desired speed range, such as an illuminated bar, lies therebetween. Accordingly, the greater the numerical difference between upper set speed and lower set speed, the relatively greater the size of the desired speed range graphic. The relatively lesser the numerical difference between upper set speed and lower set speed, the lesser the size of desired speed range graphic.

In other embodiments of the invention, the display device displays one of the driver input values. In other embodiments, more than one but less than all of the driver input values are displayed simultaneously. In some embodiments, the user selects which driver input values to display. In yet other embodiments, the display device displays all the driver input values simultaneously. Alternatively, the display can be sufficiently versatile to enable the driver to select at will, the types of information he or she wishes to be displayed concurrently. Visual display devices, which allow users to selectively display information, and display devices which concurrently display numerous pieces of display information are presently widely used in the automotive industry.

In the alternative, or in combination, an audible output can be used with or without such visual display unit. Such audible output can include anything which effectively makes the user aware of cruise control 1 settings or status, such as audible signals and/or voice synthesizations.

Switch 60 in command center 60 can be any switches capable of receiving and conveying an instruction from a user, to logic center 90 and thence to system controller 10. Both mechanical and electrical, including electronic, switches are contemplated for conveying instructions to logic mechanism 90. Command center 60 should be located-well within easy reach of the user to ensure safe operation of cruise control 1 in the vehicle.

In preferred embodiments, input logic mechanism 90 is located amongst other frequently used automobile accessory features; such as embedded within the steering wheel, attached to the steering column, attached to any levers protruding from the steering column, or within an instrument and/or control cluster, all such locations being commonly used by the automotive industry for placement of automobile accessory features, including conventional cruise control devices. In preferred embodiments, input from driver command center 60 is easily inputted into cruise control system 1 via input logic mechanism 90 of driver interface 50. To ease entering driver input into cruise control 1, display 55 and command center 60 cooperatively complement each other. As one example, if display 55 only displays one driver input value at a time, switches (not shown) on logic mechanism 90 enable the driver to navigate the display 55. Thus, a driver uses input logic mechanism 90 to select the settings of command center 60 whereas to be displayed, and subsequently uses the switches at command center 60 to define/redefine any or all of the driver input values. In preferred embodiments, cruise control system 1 enables the driver to define/redefine any of the driver input values independently of all other ones of the driver input values.

Speed sensor 40, shown in FIG. 1 is adapted to sense and transmit speed information, for example from a receiving unit. In the embodiment illustrated in FIG. 1, speed sensor 40 relays speed information to system controller 10.

One of ordinary skill in the art can readily obtain, from a variety of suppliers, an effective speed sensor 40 which sends speed information to system controller 10.

Such speed sensors 40 are presently used in the industry, such as those in automatic transmissions, wheel speed sensors used in anti-lock braking systems, and others.

Fuel controller 30 is adapted to relay fuel information 17, such as fuel flow rate information to system controller 10. In addition, fuel controller 30 receives commands 25 from system controller 10, and adjusts fuel flow rate in accord with commands 25.

Fuel flow rate in conventional electronically fuel injected internal combustion engines is controlled, at least in part, by a combination of driver input, e.g. driver throttle control, and an engine control unit (ECU) which controls, at least in part, fuel flow rate. The amount of air which enters a typical fuel injected internal combustion engine is proportional to the amount of fuel fed into the internal combustion engine.

Engine control units, e.g. electronic engine control units of typical use in the automotive industry ensure that the amount of fuel which enters an internal combustion engine is proportional to the amount of air which enters the engine by monitoring sensors and adjusting the pulse width of the fuel injectors to ensure an appropriate air/fuel mixture ratio.

Accordingly, by the driver controlling the position of the throttle valve with the accelerator pedal, the driver controls the amount of air which enters the internal combustion engine. The engine control unit adjusts fuel flow rate based, at least in part, on the position of the throttle valve or another related setting. Thus, by controlling the throttle valve, the driver correspondingly regulates fuel flow, and thus regulates engine speed.

In some embodiments, fuel controller 30 independently determines fuel information 17; e.g. by a volumetric fuel flow sensor. In other embodiments, fuel controller 30 relies on other monitoring systems typically found in vehicles to determine such fuel information 17. For example, a typical vehicle powered by an internal combustion engine can use one or more of a mass airflow sensor, an oxygen sensor, a throttle position sensor, a manifold pressure sensor, an engine speed sensor, and/or other sensors to determine, and correspondingly regulate, fuel flow rate. Thus, in some embodiments, cruise control system 1 uses one or more of the aforementioned sensing units in combination with fuel controller 30 to sense and communicate fuel-related information, and correspondingly to control fuel flow rate.

In other embodiments, fuel controller 30 utilizes fuel-related information communicated to, and by the conventional engine control unit and/or powertrain control modules. In some embodiments, fuel controller 30 is an integral part of the engine control unit.

Fuel controller 30 receives commands 25 from system controller 10, and implements such commands 25 by effectuating a change in fuel flow rate. As conventional in the automotive industry, in some embodiments, fuel controller 30 uses an electronically controlled vacuum actuator to receive/implement command 25 from system controller 10. The vacuum actuator, typically by a cable, controls the position of a throttle valve, which in turn dictates the amount of air, and correspondingly, the amount of fuel the internal combustion engine receives; thus the conventional vacuum actuator is used by fuel controller 30 to control engine speed.

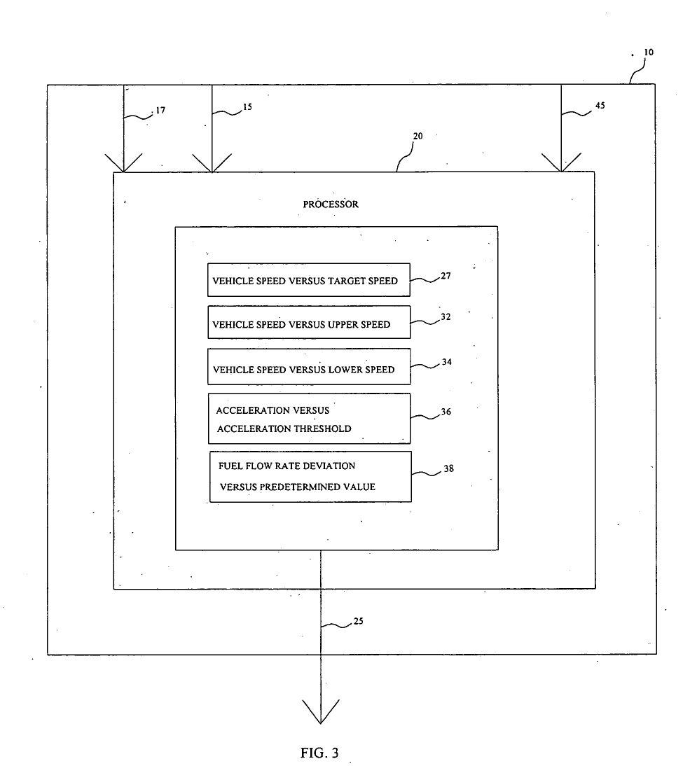

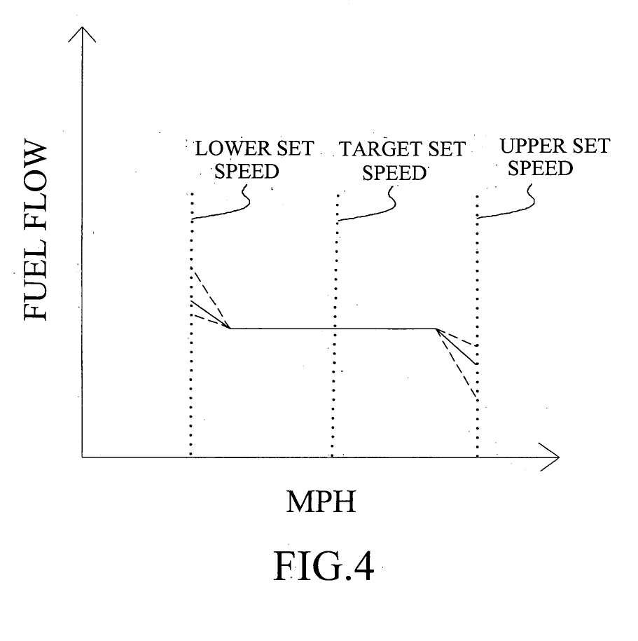

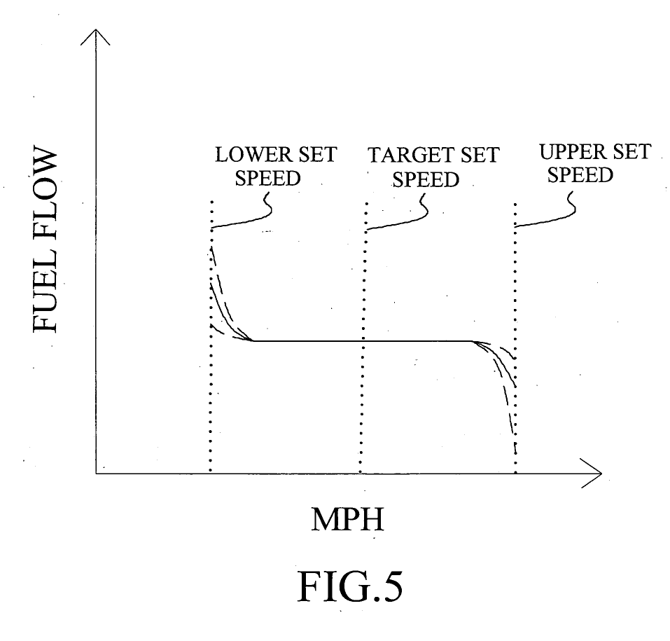

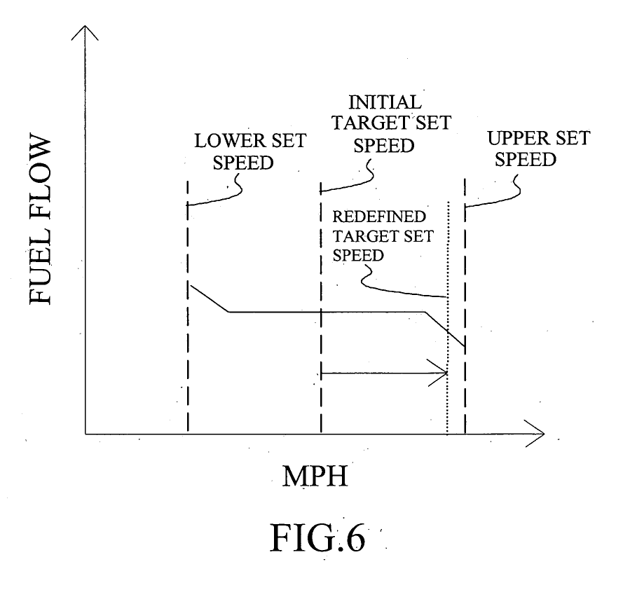

As shown in FIG. 3, in preferred embodiments, system controller 10 uses a processor 20, preferably a microprocessor, to analyze information 15, 17, 25, 45 as received in controller 10, in order generate an updated fuel command 25. Processor 20 receives input, such as speed information 45, driver information 15, and fuel information 17, and information related to the most recent command 25, and compares such information 15, 17, 25, 45 to comparative criteria such as vehicle real time speed deviation from target speed 27, vehicle real time speed deviation from upper speed 32, vehicle real time speed deviation from lower speed 34, acceleration deviation from acceleration threshold 36, and fuel flow rate deviation from a predetermined fuel flow rate value 38, to determine whether a change command 25 should be generated and sent to fuel controller 30. In addition to being a receiver, processor 20 is also a transmitter to convey commands 25 to fuel controller 30, as well as optionally to send braking commands 51 to brakes 52 if and as vehicle real time speed exceeds the upper set speed by a predetermined value.

Processor 20 can use any effective method of comparing information 15, 17, 25, 45 with driver input at command center 60, to determine whether a change command 25 should be sent to fuel controller 30. In preferred embodiments, processor 20 compares information 15, 17, 25, 45 with driver input at command center 60, and against comparison criteria 27, 32, 34, 36, 38, thereby to determine whether a command 25 should be generated commanding change in fuel flow rate.

In preferred embodiments, processor 20 uses a logic-based system to make such an evaluation. The logic-based evaluations are periodically made at generally short intervals. In one specific embodiment, system controller 10 includes an Intel® MCS®96 16-Bit Microcontroller. System controller 10 compares information 15, 17, 25, 45 with driver input 60, and evaluates such comparison against comparison criteria 27, 32, 34, 36, 38 once every 1/10 of a second. In some embodiments, the evaluation is performed once every 1/100 of a second, alternatively more frequently.

As one example of the ongoing evaluations which are being made by controller 10, the controller 10 makes a comparison 32 between vehicle speed and the upper set speed or set by switch 65. As real time vehicle speed approaches the upper set speed, e.g. within one to three miles per hour, system controller 10 generates a change command 25, commanding fuel controller 30 to reduce the fuel flow rate. As a second example, as real time vehicle speed declines toward the target set speed from the upper set speed, system controller 10 generates a change command 25, commanding fuel controller 30 to increase the fuel flow rate so as to smooth transition to the target set speed. In some embodiments, once the vehicle real time speed stabilizes at the target set speed, the fuel flow rate is held constant until a subsequent deviant response 27, 32, 34, 36, 38 is recognized by system controller 10, wherein subsequent action is taken to again adjust fuel flow rate thereby to attenuate the deviant response.

As another example of the ongoing evaluation being made by controller 10, the controller 10 makes a comparison 34 between real time vehicle speed and lower set speed. As real time vehicle speed approaches the lower set speed, e.g. within one to three miles per hour, system controller 10 generates a change command 25, commanding fuel controller 30 to increase the fuel flow rate. As the vehicle speed increases toward target set speed from lower set speed, system controller 10 generates a command 25, commanding fuel controller 30 to decrease fuel flow so as to smooth transition to the target speed. In some embodiments, once the real time vehicle speed stabilizes at the target set speed, the fuel flow rate is held constant until a subsequent deviant response 27, 32, 34, 36, 38 is recognized by system controller 10 whereupon subsequent action is taken to again adjust fuel flow rate thereby to attenuate the deviant response.

In some embodiments, system controller 10 nominally seeks to maintain the target set speed, while operating within the desired speed range between the upper speed and lower speed. As vehicle speed deviates from the target set speed, but before vehicle speed reaches one of the upper set speed and the lower set speed, system controller 10 commands a change in fuel flow rate, thereby to attenuate vehicle speed change by the time real time vehicle speed reaches the respective upper or lower set speed.

As real time vehicle speed gets progressively closer to the respective upper set speed or lower set speed, the command 25 being sent from system controller 10 to fuel controller 30 commands a progressively increasing rate of change of fuel flow so as to attenuate the rate of vehicle speed which can be attributed to rate of fuel flow. The rate of change of fuel flow rate can correspond as either first or second order functions of change in real time vehicle speed. Thus, the rate of change of fuel flow rate be a straight line function of vehicle speed change, or as e.g. second or greater order exponential function.

Thus, cruise control system 1 of the invention offers fuel efficiency gains over conventional cruise control systems by maintaining constant fuel flow over a driver determined speed range, in combination with responding to vehicle speed fluctuation outside the set speed range in a fuel-efficient manner. Namely, a fuel flow rate change instruction to attenuate vehicle speed gain/loss is not sent if vehicle speed lies within the desire operating speed range.

In some embodiments, system controller 10 commands that fuel controller 30 hold fuel flow rate relatively constant until vehicle speed approaches one of the upper set speed and the lower set speed. Thus, cruise control system 1 enables a user to influence the fuel efficiency of the vehicle being controlled by cruise control system 1 by defining the desired operating speed range between the upper set speed and the lower set speed. A relatively larger desired operating speed range corresponds generally to a relatively higher vehicle fuel efficiency, while a relatively smaller desired operating speed range corresponds generally to a relatively lower vehicle fuel efficiency.

In some embodiments, system controller 10 issues a delayed command 25 based on responses 27, 32, 34, 36, 38. As one example, the result of a deviant response, 27, 32, 34, 36, 38 starts a timer which expires before a change command 25 is sent, provided that the deviant response 27, 32, 34, 36, 38 is still being detected as deviant by system controller 10 when the timer expires. For example, for a long uphill stretch, system 1 holds vehicle speed at the lower set speed for the timer period, then increases real time vehicle speed to the target set speed, and holds vehicle speed at the target set speed until the vehicle approaches the top of the hill.

In some embodiments, responses 27, 32, 34, 36, 38 trigger sending resulting comparative information and/or other vehicle operational information, e.g. 15, 17, 25, 45 to a database in a controller on the vehicle, which can be accessed by controller 10. Such database can be e.g. embedded in controller 10, or can be part of the vehicle ECU. Subsequently, system controller 10 analyzes results 27, 27, 32, 34, 36, 38, driver input through command center 60, and vehicle operational information 15, 17, 25, 45 with respect to each other, and with respect to historical information stored in the database. Accordingly, system controller 10 sends commands 25 based at least in part on historical information, be it a command 25 in conformity with the previously sent command 25, or be it a differing command 25.

In other embodiments of the invention, system controller 10, and preferably processor 20, evaluates change in vehicle speed over time; thus, calculating vehicle acceleration. In such embodiments, processor 20 evaluates vehicle acceleration versus a predetermined acceleration threshold, as suggested at 36 in FIG. 3. When vehicle acceleration approaches the predetermined acceleration threshold, system controller 10 sends commands 25 to fuel controller 30 commanding a fuel flow rate change requiring magnitude of fuel flow rate change based on the rate of acceleration.

Such predetermined acceleration threshold can be based on any of a variety of criteria. One example is to use an acceleration threshold to prevent a driver from accelerating at an unusually high rate. When such an acceleration threshold is approached, system controller 10 sends a command 25 to fuel controller 30 to limit fuel flow rate, or rate of change, to a predetermined value. Such a command 25 can limit wear on engine, drive train, and/or other vehicular parts which may be compromised by overly aggressive driving.

Also, use of an acceleration threshold can be advantageous as the vehicle crests the top of a hill. As the slope of a hill decreases toward the crest, the vehicle gains speed and acceleration if fuel flow rate is maintained constant. A vehicle cresting a hill can quickly gain speed and acceleration, particularly when the hill topography quickly transitions from a steep uphill slope to a steep downhill slope.

Should vehicle acceleration adequately approach the defined acceleration threshold, commands 25 from system controller 10 command that fuel controller 30 decrease fuel flow rate, thus preventing the vehicle from cresting the hill at an undesirably high rate of speed.

Cruise control system 1 optionally includes a database adapted to receive, store, and submit fuel flow rate information to other components within cruise control system 1, and/or to components outside of cruise control system 1, as well as being adapted to use such information in generating commands 25. In some embodiments, the database contains default/model fuel flow rates, which respectively correspond to vehicle speeds. The driver selects the target speed, and system controller 10 sends a command 25 to fuel controller 30 to adjust fuel flow rate to coincide with the model fuel flow rate stored in the database, which corresponds to the target speed.

In the alternative, the default base fuel flow rate can be determined, and defined prior to consumer sale of a vehicle having cruise control system 1. Default base fuel flow rate is preferably determined in a controlled; e.g. laboratory setting, with constant environmental variables such as ambient temperature, barometric pressure, elevation, wind speed, and others, directed to a specific make and model of vehicle.

In some embodiments, the default base fuel flow rate is defined by determining fuel flow rate coincident vehicle speed by using a chassis dynamometer, which simulates road conditions by controlling inertial “road load” of rotating drums which the tested vehicle's drive wheels/tires rotate upon. Default base fuel flow rates, which correspond to respective vehicle speeds as determined by the dynamometer test are then defined by cruise control system 1, e.g. entered as data into a database. In some embodiments, the database is stored on ROM memory as part of the system controller, alternatively the database is stored on programmable programable EEPROM memory. In other embodiments, the database is stored on RAM, alternatively the database is stored upon another form of storage media, e.g. a hard drive.

In some embodiments, base fuel flow rate is defined by vehicle operation during operation of the vehicle containing cruise control system 1. The driver selects the target set speed, and system controller 10 defines base fuel flow rate as the fuel flow rate coincident the target set speed at the time the time the target set speed was selected.

Cruise control system 1 enables a driver to subsequently redefine the base fuel flow rate by entering driver input at command center 60. A driver can define a first base fuel flow rate coincident with the target set speed while the vehicle is climbing a long uphill slope, and subsequently redefine a second, different base fuel flow rate coincident with the same target set speed while descending down a long downhill slope.

Cruise control system 1 enables the driver to redefine the target speed while holding constant the desired operating speed range, between the upper set speed and the lower set speed, as illustrated in FIG. 6. FIG. 6 illustrates what a typical driver may consider an extreme redefinition of the target set speed.

### Operation

In some embodiments, a driver sets at least one of the upper set speed and the lower set speed independently of the target set speed. In other embodiments, the driver sets the upper set speed and the lower set speed, and cruise control system 1 selects the initial target set speed within the speed range defined by the upper set speed and the lower set speed, and according to predefined conditions. The predefined conditions can be set, or reset, dynamically at the will of the driver through the driver input command center 60.

In some embodiments, the predefined conditions can be hard wired into e.g. system controller 10. In some embodiments, the predefined conditions can be programmable, but through a separate interface, not the driver input command center 60, such as an interface accessible by a service technician through a PC or other computer interface.

In yet other embodiments, the driver selects one of the upper set speed and the lower set speed, and the cruise control system 1 selects the target set speed and any remaining ones of the upper set speed,and the lower set speed. In any of the above mentioned embodiments, cruise control system 1 enables the driver to define/redefine any of the initially defined ones of the upper set speed, the target set speed, and the lower set speed while cruise control system 1 is in operation, actively controlling speed of the vehicle.

Defining/redefining any of the upper set speed, the target set speed, and the lower set speed independently of each other allows the driver to exercise extensive control over cruise control system 1. Thus, a driver has considerable control over vehicle performance while using cruise control system 1.

By contrast, conventional cruise control systems typically define the upper set speed and the lower set speed internally, and as a result of the setting of the target set speed. Specifically, commercially mass-produced conventional cruise control systems typically provide a cruise control governor which adjusts engine torque versus vehicle speed in accordance with a preprogrammed “droop curve.” Default operating parameters of conventional cruise control systems are not so flexible as to accommodate the individual driver's desire regarding the upper and lower set speeds, and/or redefinition of other aspects of the droop curve.

Definition/redefinition of the upper set speed and the lower set speed, as enabled by the present invention, directly affects the magnitude of the difference between the upper set speed value and the lower set speed value, thus directly affecting the desired operating speed range of the vehicle while being controlled by the cruise control system. Accordingly, cruise control system 1 enables a user to define/redefine a relatively wider range of operating speeds between the upper set speed and the lower set speed in the interest of fuel economy. However, another user of cruise control system 1 can define a relatively narrower range of operating speeds between the upper set speed and the lower set speed in the interest of consistent travel speed, or higher overall travel speed.

Use of a conventional cruise control system generally results in a consistent response, each time the vehicle speed deviates from an equivalent set speed by an equivalent magnitude. For example, on the same “stretch of road,” when a driver defines the set speed at 65 miles per hour on a conventional cruise control system, and the vehicle speed falls to 60 miles per hour, the conventional cruise control system generally responds in the same fashion as it did the last time the driver defined the set speed at 65 miles per hour and the vehicle speed fell to 60 miles per hour. Likewise, the conventional system generally responds in the same manner the next time such speed deviation occurs.

By contrast, cruise control system 1 enables a user to influence the action taken by cruise control system 1, in relation to current “vehicle speed versus target speed” 27. Cruise control system 1 enables a user to, for example, define/redefine the lower set speed to a value e.g. 50 miles per hour, such that a fuel flow rate change is not implemented to attenuate the vehicle speed loss, as vehicle speed falls to 60 miles per hour from a target set speed of 65 miles per hour.

In some embodiments, the driver redefines the operating speed range between the upper set speed and the lower set speed in one action. This is desirable when, for example, the driver wishes to increase, alternatively decrease the desired operating speed range between the upper set speed and the lower set speed, yet retain the target set speed.

To increase the desired operating speed range, in some embodiments, the upper set speed value and the lower set speed value are caused to simultaneously diverge from the target set speed. In some embodiments, the relationship of the difference between the upper set speed and the target set speed, versus the difference between the lower set speed and the target set speed remains constant. As one example, when the difference between the upper set speed and the target set speed, and the difference between the lower set speed and the target set speed have the same magnitude prior to redefinition of the desired operating speed range, the differences have a new equivalent magnitude after redefinition of the desired operating speed range.

In some embodiments, the driver changes the target set speed without changing either the upper set speed or the lower set speed, thereby to change the average speed without changing the upper and lower limits.

In some embodiments, the operator defines/redefines the speed range by changing the magnitude of the difference between the target set speed value and the lower set speed. A definition/redefinition of the lower set speed in relation to the target set speed is advantageous when a driver wishes to retain the upper parameter performance of cruise control system 1; thus retain upper set speed 85, yet wishes to allow vehicle speed to fall further below the target set speed than previously. For example, if a vehicle is momentarily traveling into a strong headwind, the driver may wish to allow vehicle speed to fall further below the target set speed without triggering an increase in fuel flow, thus effectively limiting fuel consumption per distance traveled.

There are other situations in which the fuel flow increase response of a conventional cruise control is greater than what the user finds acceptable. For example, when the vehicle is traveling up a steeply graded hill, the driver of the vehicle may not want the vehicle cruise control system to aggressively seek the set speed due to the corresponding increase in fuel flow required to maintain the set speed while climbing the hill.

Rather, while climbing a steeply graded hill, the driver may prefer to allow the vehicle speed to drop well below the target set speed in the interest of vehicle fuel economy. Accordingly, with a conventional cruise control, the driver must disengage the cruise control system and manually control vehicle speed e.g. with the accelerator pedal so as to deliver what the driver considers an acceptable fuel flow to the internal combustion engine. Alternatively, the a user of a conventional cruise control resets the target speed, correspondingly affecting other cruise control operating parameters of the vehicle.

In contrast, a user of cruise control system 1 of the present invention can define/redefine the lower set speed to a lower value in relation to the target set speed e.g. in response to visual impression of a upcoming change in road condition, thus, affecting the relationship 34 between the real time vehicle speed and the lower set speed so as to not trigger a change command response 25. Accordingly, commands 25 sent by system controller 10 to fuel controller 30 do not command fuel controller 30 to change fuel flow rate. Namely, fuel flow rate does not increase, and correspondingly less fuel is consumed than if fuel flow rate had been increased.

Alternatively, in some situations, the fuel flow reduction of a conventional cruise control may be greater, and occur sooner than what a user finds acceptable. For example while traveling downhill, a conventional cruise control system quickly reduces fuel flow as vehicle speed exceeds the set speed. However, when driving through repetitively hilly terrain, a driver may desire a vehicle speed to go above the set speed to gain a momentum advantage from gravity on the down-slope side of a hill, in order to help carry the vehicle up a subsequent hill.

Cruise control system 1 of the present invention enables a user to define/redefine the upper set speed in relation to the target set speed. Therefore, the driver can increase the value of the upper set speed when it is desirable to obtain more speed while traveling downhill. Accordingly, the vehicle is enabled to gain more speed traveling downhill, thus taking advantage of gravity to increase vehicle speed, which reduces the amount of fuel required to power the vehicle up and over a subsequent hill.

Defining/redefining the relationship between the target set speed and the upper set speed is further advantageous when a driver wishes to retain the relationship between the target set speed and the lower set speed. For example, a driver traveling along hilly terrain may wish to retain the current relationship between the target set speed and the lower set speed, if the driver finds the vehicle speed while traveling uphill to be adequate.

However, in addition to current vehicle speed while traveling uphill, the driver may prefer that the vehicle gain additional speed while traveling downhill to reduce the amount of energy required to climb the next subsequent hill. As previously discussed, the driver can define/redefine the relationship between the target set speed and the upper set speed, such as by increasing the value of the upper set speed and retaining the value of the target set speed. Vehicle speed is then allowed to increase while traveling downhill as dictated by the defined/redefined the upper set speed, while retaining the previous hill climbing speed as dictated by the lower set speed.

In other embodiments, the driver sets a the target set speed and also selects a terrain type 95. Cruise control system 1 sets default upper seed 65 and the lower set speed parameters, which correspond to the selected terrain type. For example, if a driver selects a level ground terrain type, cruise control system 1 defaults to an the upper set speed and a lower set speed, which have values that are relatively close to each other. Thus, the speed of the vehicle will remain fairly constant.

However, if the driver selects a hilly terrain type, e.g. on a graduated scale of 1-5, cruise control system 1 defaults to an the upper set speed and a lower set speed, which have values that are relatively farther apart from each other, depending on the scale numeral selected, and on the default parameter/pre-set into system controller 10. Thus, the speed of the vehicle can fluctuate more without inducing a fuel flow based change command 25. Accordingly, the fuel efficiency of the vehicle is enhanced while driving through hills and using the hilly terrain type option, as opposed to a lever ground terrain type option.

In any of the above examples, preferred embodiments enable the driver to define/redefine any of the upper set speed, the target set speed, the lower set speed, or the terrain type via logic input mechanism 90 through command center 60 at any time, and under any condition, while the cruise control system 1 is in operation controlling the speed of a ground-engaging vehicle.

In all embodiments of the invention, the target set speed is always within the speed range defined by the upper and lower set speeds. While the target set speed can be coincident with either the upper set speed or the lower set speed, the target set speed can never be greater than the upper set speed, or less than the lower set speed.

As shown in FIG. 4, the current invention commands a fuel flow response based on the relationship between real time vehicle speed, the lower set speed, the target set speed, and the upper set speed. When the real time vehicle speed value lies generally between the upper set speed value and the lower set speed value, there is generally no change in fuel flow rate.

In some embodiments, the fuel flow rate change is generally linear, relative to difference between the real time vehicle speed value and the either the lower set speed value or the upper set speed value, as shown in FIG. 4. The slope of the line, indicating change in fuel flow rate, corresponds to the rate of vehicle speed change. As indicated by the dashed lines, as vehicle speed approaches either the lower set speed or the upper set speed, a relatively rapid change in vehicle speed corresponds to a relatively higher change in fuel flow. By contrast, as vehicle speed approaches either the lower set speed or the upper set speed, a relatively slower change in vehicle speed corresponds to a relatively lesser change in fuel flow.

In some embodiments, the fuel flow rate change is exponential, relative to the difference between the real time vehicle speed and either the lower set speed or the upper set speed, as illustrated in FIG. 5. The magnitude of the fuel flow change is depends upon how quickly the vehicle speed approaches either the lower set speed or the upper set speed. Relatively rapid changes in vehicle speed correspond to relatively higher changes in fuel flow; whereas relatively slower changes in vehicle speed correspond to relatively lesser changes in fuel flow.

The capability of controlling the operational parameters of cruise control system 1, particularly individual values at switches 65, 75, 85, 95 of driver input at command center 60, independently of each other enables the driver to further create custom working features of cruise control system 1.

A vehicle driver can define/redefine the lower set speed to a value of zero, e.g. as a stop change option, in anticipation of a stop. Under such condition, system controller 10 sends commands 25 to fuel controller 30 to reduce fuel flow accordingly. In some embodiments system controller 10 recognizes that setting the lower set speed to zero indicates an approaching stop, and sends commands 25 to fuel controller 30 to gradually reduce fuel flow so as to smoothly transition real time vehicle speed from the current vehicle speed to a fuel flow rate consistent with engine idling speed, thereby approaching a vehicle speed of zero.

In preferred embodiments, input logic mechanism 90 includes a selectable “stop” feature and/or a selectable “gradual stop” feature, e.g. as a stop change option, whereby the user can engage such “stop” feature or “gradual stop” feature in anticipation of a stop without necessarily changing any of the set speeds, but while retaining the cruise control system in general automatic control of vehicle speed.

Upon engagement of a “stop” feature via input logic mechanism 90, system controller 10 sends commands 25 fuel controller 30 to gradually reduce fuel flow so as to smoothly transition vehicle speed from the current vehicle speed to a fuel flow. rate consistent with engine idling speed, thereby approaching a real time vehicle speed of zero.

By using a vehicle cruise control system 1 of the current invention, the user controls when the vehicle cruise control system commands an action, thus the user controls speed fluctuation parameters. Therefore, the user can tailor the operation of the vehicle cruise control system to meet his or her needs by selectively defining an acceptable speed range; be it a narrow speed range to closely maintain a desired speed, or a wide speed range to allow greater speed variation so as to increase the fuel economy of the vehicle, or anything in between.

In some environmental conditions, conventional cruise control systems can lead to poor fuel economy. For instance, when a vehicle is traveling into a strong head wind, or up a hill, the conventional cruise control system strives to maintain the set speed, and thus fuel flow is increased as necessary to return the vehicle to the set speed.

By aggressively seeking the set speed, the conventional cruise control system commands frequent changes in fuel flow rate and thereby reduces vehicle fuel economy. By contrast, the present invention enables the driver to redefine the speed range to enable a greater deviation from a target set speed while leaving the cruise control system in control of vehicle speed. Accordingly, increased fuel flow responses are implemented less frequently by the present invention, when the user defines a relatively larger operating speed range, than is implemented by a conventional cruise control system operating in a corresponding environment. Fewer changes in fuel flow rate typically reduce the amount of fuel consumed by an internal combustion engine over a given course of travel, thus vehicle fuel economy is improved.

When a vehicle is traveling downhill, a conventional cruise control system utilizes gravitational energy to maintain the set speed, but does not utilize gravitational energy in conjunction with a constant fuel flow to increase vehicle speed beyond the set speed. By contrast, the present invention allows the driver to redefine the speed range while the cruise control system is in operation, to allow a greater deviation from a target set speed without a fuel flow reduction.

Thus, a user of the present invention in a vehicle traveling downhill can instruct that the vehicle cruise control system not reduce fuel flow as quickly as would a conventional cruise control system. Accordingly, a vehicle utilizing the present invention can have a greater speed, thus more mechanical energy/momentum as it approaches the bottom of the hill. If the vehicle is traveling along terrain with multiple consecutive hills, the increased mechanical energy is advantageous when climbing the next consecutive hill. A vehicle with more mechanical energy requires less energy, thus less fuel, to climb a hill than if the vehicle were traveling at a slower set speed, with less mechanical energy.

In some embodiments, system controller 10 issues a delayed command 25 based on responses 27, 32, 34, 36, 38. As one example, the result of a deviant response, 27, 32, 34, 36, 38 starts a timer which expires before a change command 25 is sent, such change command being sent only if the deviant response 27, 32, 34, 36, 38 is still being detected as deviant by system controller 10 when the timer expires. The timer function enables the driver to allow cruise control system 1 to remain in control of vehicle speed, while the vehicle travels over quickly varying terrain types, or through periodic strong wind gusts.

As one example, when the vehicle travels up a short-steep hill which causes vehicle speed to fall so as to approximate the lower set speed, system controller 10 can start a timer. When the vehicle crests the short-steep hill prior to expiration of the timer, system controller 10 does not send a command 25 to fuel controller 30, commanding an increase in fuel flow rate. Thus fuel flow rate remains constant despite the vehicle speed approximating or perhaps falling below, the lower set speed. Such delayed command can, as desired, be an operator activated option.

Allowing a device, e.g. a vehicle cruise control system, to control the speed of a vehicle is desirable by alleviating the driver of the necessity of performing real time speed control. However, increased vehicle fuel efficiency is also desirable. Accordingly, the most highly preferred embodiments are those which enable a driver/user to have extensive control over the operating parameters of cruise control system 1, so as to enable the driver to tailor the operation of cruise control system 1 to meet his or her needs, be it fuel economy, or travel speed consistency, or some of each.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

Having thus described the invention, what is claimed is:

1. A vehicle cruise control system, comprising:
(a) a system controller adapted to process information and to establish a cruise control speed range defined by an upper set speed and a lower set speed, a target set speed being defined in such speed range, said system controller comprising a processor, and being adapted to generate and send a command;
(b) a speed sensor adapted to sense vehicle speed and to communicate vehicle speed information to the system controller;
(c) a fuel controller adapted to sense fuel flow information, and to communicate fuel flow information to said system controller, said fuel controller being further adapted to receive a command from said system controller, and to execute an action corresponding to such command; and
(d) a driver interface adapted to receive driver input and to communicate such driver input to said system controller, such driver input including at least one of a driver determined such upper set speed, and a driver determined such lower set speed, wherein at least one of the upper set speed and the lower set speed can be selected by such driver independent of the target set speed.

2. A vehicle cruise control system as in claim 1 wherein said processor of said system controller generates the command when vehicle speed approximates the driver determined upper set speed, or vehicle speed approximates the driver determined lower set speed, and wherein speeds between the upper set speed and the lower set speed generally define a desired operating speed range.

3. A vehicle cruise control system as in claim 1 wherein the command is generated in response to the vehicle speed being proximate the lower set speed, the command comprising an instruction communicated to said fuel controller to change fuel flow rate so as to attenuate loss of vehicle speed.

4. A vehicle cruise control system as in claim 3 wherein the command further comprises commanding a decrease in fuel flow rate as the vehicle speed approaches, and prior to the vehicle speed reaching, the target set speed from the lower set speed.

5. A vehicle cruise control system as in claim 1 wherein said driver input comprises a driver determined upper speed, a driver determined lower speed, and a driver determined target speed.

6. A vehicle cruise control system as in claim 1 wherein said driver input comprises a driver determined upper set speed, and a driver determined lower set speed,
said processor being adapted to select an initial default target set speed between the upper set speed and the lower set speed, said system controller being adapted to process vehicle speed, fuel flow, and driver input to generate a command, said system controller being adapted to communicate such command to said fuel controller.

7. A vehicle cruise control system as in claim 1 wherein said driver input comprises a driver determined target set speed, said system controller providing at least one of an upper set speed and a lower set speed,
the cruise control system being adapted to receive and implement ongoing redefinition of the upper set speed, the lower set speed, and/or the target set speed while said vehicle cruise control system is in operation controlling speed of a vehicle.

8. A vehicle cruise control system as in claim 1, said driver input including at least one of an upper set speed, and a lower set speed,
said processor being adapted to select a target set speed, and the remaining one of the upper set speed and the lower set speed, consistent with the driver input, thereby to establish a target set speed, and a desired operating speed range between the upper set speed and the lower set speed.

9. A vehicle cruise control system as in claim 1 wherein the command is generated in response to the vehicle speed being proximate the upper set speed, the command comprising an instruction communicated to said fuel controller to change fuel flow rate so as to attenuate increase in vehicle speed.

10. A vehicle cruise control system as in claim 9 wherein the command further comprises commanding an increase in real time fuel flow rate as the vehicle speed approaches, and prior to the vehicle speed reaching, the target set speed from the upper set speed.

11. A vehicle cruise control system as in claim 1, said fuel flow controller generally maintaining a constant fuel flow rate relative to the fuel flow rate corresponding to the target set speed, wherein said processor of said system controller generates the command when vehicle speed approximates the upper set speed, or vehicle speed approximates the lower set speed.

12. A vehicle cruise control system as in claim 11, said vehicle cruise control system further comprising a database adapted to store fuel flow information,
said command based at least in part on such fuel flow information stored in said database.

13. A vehicle cruise control system as in claim 11 wherein the command is generated in response to the vehicle speed being proximate the lower set speed, the command comprising an instruction communicated to said fuel controller to change fuel flow rate so as to attenuate loss of vehicle speed.

14. A vehicle cruise control system as in claim 13 wherein the command further comprises commanding a decrease in real time fuel flow rate as the vehicle speed approaches, and prior to the vehicle speed reaching, the target set speed from the lower set speed.

15. A vehicle cruise control system as in claim 13 wherein the command further comprises commanding an exponential decrease in the change in fuel flow rate, from the real time fuel flow rate, toward the fuel flow rate corresponding to the target set speed.

16. A vehicle cruise control system as in claim 11 wherein the command is generated in response to the vehicle speed being proximate the upper set speed, the command comprising an instruction communicated to said fuel controller to change real time fuel flow rate so as to attenuate increase in vehicle speed.

17. A vehicle cruise control system as in claim 16 wherein the command further comprises commanding an increase in real time fuel flow rate as the vehicle speed approaches, and prior to the vehicle speed reaching, the target set speed from the upper set speed.

18. A vehicle cruise control system as in claim 16 wherein the command further comprises commanding an exponential decrease in the change in fuel flow rate, from the real time fuel flow rate, toward the fuel flow rate corresponding to the target set speed.

19. A vehicle cruise control system as in claim 1 wherein said cruise control system is adapted to receive and implement ongoing driver inputs changing any of the upper set speed, the lower set speed, and the target set speed, while said vehicle cruise control system is in operation controlling speed of a vehicle.

20. A vehicle cruise control system as in claim 1, said system controller being further adapted to process vehicle speed, and analyze changes in vehicle speed versus time to thereby compute acceleration, said system controller being adapted to analyze the combination of acceleration, vehicle speed, fuel flow rate, and driver input to generate such command.

21. A vehicle cruise control system as in claim 20 wherein said system controller generates the command when absolute acceleration of the vehicle exceeds a predetermined acceleration rate threshold, and wherein the command comprises commanding a corresponding change in fuel flow rate based, at least in part, on the acceleration rate.

22. A vehicle cruise control system as in claim 1 wherein the said vehicle cruise control system maintains the lower set speed for a predetermined time period, subsequently said system controller commands said fuel controller to increase real time fuel flow rate.

23. A vehicle cruise control system as in claim 1, said input including defining a driver anticipated stop, said system controller commanding said fuel controller to reducing fuel flow, accommodating such driver anticipated stop.

24. A vehicle comprising a vehicle cruise control system as in claim 1.

25. A vehicle cruise control system comprising:
(a) a system controller adapted to process information, said system controller comprising a processor, and being adapted to generate and send a command;
(b) a speed sensor adapted to sense vehicle speed and to communicate vehicle speed information to the system controller;
(c) a fuel controller adapted to sense fuel flow information, and to communicate fuel flow information to said system controller, said fuel controller being further adapted to receive a command from said system controller, and to execute an action corresponding to such command; and
(d) a driver interface adapted to receive driver input and to communicate such driver input to said system controller, such driver input including a driver determined target set speed, and a plurality of driver selectable terrain types, each of said driver selectable terrain types having a predetermined upper set speed and a predetermined lower set speed, relative to the target set speed, corresponding to the driver selectable target set speed,
said processor being adapted to process the vehicle speed, the fuel flow, and the driver input to generate a command, said system controller being adapted to communicate such command to said fuel controller.

26. A vehicle cruise control system as in claim 25 wherein said processor of said system controller generates the command when vehicle speed approximates the upper set speed, or vehicle speed approximates the lower set speed, and wherein speeds between the upper set speed and the lower set speed generally define a desired operating speed range.

27. A vehicle cruise control system as in claim 25 wherein the command is generated in response to the vehicle speed being proximate the lower set speed, the command comprising an instruction communicated to said fuel controller to change fuel flow rate so as to attenuate loss of vehicle speed.

28. A vehicle cruise control system as in claim 27 wherein the command further comprises commanding a decrease in fuel flow rate as the vehicle speed approaches, and prior to the vehicle speed reaching, the driver determined target set speed from the lower set speed.

29. A vehicle cruise control system as in claim 25 wherein the command is generated in response to the vehicle speed being proximate the upper set speed, the command comprising an instruction communicated to said fuel controller to change fuel flow rate so as to attenuate increase in vehicle speed.

30. A vehicle cruise control system as in claim 29 wherein the command further comprises commanding an increase in relative fuel flow rate as the vehicle speed approaches, and prior to the vehicle speed reaching, the driver determined target set speed from the upper set speed.

31. A vehicle cruise control system as in claim 25, said fuel flow controller generally maintaining a constant fuel flow rate relative to the fuel flow rate corresponding to the driver determined target set speed, wherein said processor of said system controller generates the command when vehicle speed approximates the upper set speed, or vehicle speed approximates the lower set speed.

32. A vehicle cruise control system as in claim 31, said vehicle cruise control system further comprising a database adapted to store fuel flow information, said command based at least in part on such fuel flow information stored in said database.

33. A vehicle cruise control system as in claim 31 wherein the command is generated in response to the vehicle speed being proximate the lower set speed, the command comprising an instruction communicated to said fuel controller to change fuel flow rate so as to attenuate loss of vehicle speed.

34. A vehicle cruise control system as in claim 33 wherein the command further comprises commanding a decrease in real time fuel flow rate as the vehicle speed approaches, and prior to the vehicle speed reaching, the driver determined target set speed from the lower set speed.

35. A vehicle cruise control system as in claim 33 wherein the command further comprises commanding an exponential decrease in the change in fuel flow rate, from the real time fuel flow rate, toward the fuel flow rate corresponding to the driver determined target set speed.

36. A vehicle cruise control system as in claim 31 wherein the command is generated in response to the vehicle speed being proximate the upper set speed, the command comprising an instruction communicated to said fuel controller to change real time fuel flow rate so as to attenuate increase in vehicle speed.

37. A vehicle cruise control system as in claim 36 wherein the command further comprises commanding an increase in real fuel flow rate as the vehicle speed approaches, and prior to the vehicle speed reaching, the driver determined target set speed from the upper set speed.

38. A vehicle cruise control system as in claim 36 wherein the command further comprises commanding an exponential decrease in change in fuel flow rate, from the real time fuel flow rate, toward the fuel flow rate corresponding to the driver determined target set speed.

39. A vehicle cruise control system as in claim 25 wherein said cruise control system is adapted to receive and implement ongoing driver inputs changing any of the upper set speed, the lower set speed, and the target set speed, while said vehicle cruise control system is in operation controlling speed of a vehicle.

40. A vehicle cruise control system as in claim 25, said system controller being further adapted to process vehicle speed, and analyze changes in vehicle speed versus time to thereby compute acceleration, said system controller being adapted to analyze the combination of acceleration, vehicle speed, fuel flow rate, and driver input to generate such command.

41. A vehicle cruise control system as in claim 40 wherein said system controller generates the command when absolute acceleration of the vehicle exceeds a predetermined acceleration rate threshold, and wherein the command comprises commanding a corresponding change in fuel flow rate based, at least in part, on the acceleration rate.

42. A vehicle cruise control system as in claim 25 wherein the said vehicle cruise control system maintains the lower set speed for a predetermined time period, subsequently said system controller commands said fuel controller to increase real time fuel flow rate.

43. A vehicle cruise control system as in claim 25, said input including defining a driver anticipated stop, said system controller commanding said fuel controller to reducing fuel flow, accommodating such driver anticipated stop.

44. A vehicle comprising a vehicle cruise control system as in claim 25.

45. A method of controlling vehicle speed comprising:
(a) processing information in a system controller and establishing a cruise control speed range defined by an upper set speed and a lower set speed, a target set speed being defined in such speed range;
(b) sensing vehicle speed in a speed sensor and communicating vehicle speed information to the system controller;
(c) sensing fuel flow information in a fuel controller and communicating such fuel flow information from said fuel controller to said system controller, said fuel controller being further adapted to receive a command from said system controller, and to execute an action corresponding to such command; and
(d) receiving driver input in a driver interface and communicating such driver input to said system controller, such driver input including at least one of a driver determined such upper set speed, and a driver determined such lower set speed, wherein at least one of the upper set speed and the lower set speed can be selected by such driver independent of the target set speed.

46. A method of controlling vehicle speed as in claim 45 wherein the command is generated in response to the vehicle speed being proximate the lower set speed, the command comprising an instruction transmitted to said fuel controller to change fuel flow rate so as to attenuate loss of vehicle speed.

47. A method of controlling vehicle speed as in claim 45 wherein the command is generated in response to the vehicle speed being proximate the upper set speed, the command comprising an instruction transmitted to said fuel controller to change fuel flow rate so as to attenuate increase in vehicle speed.

48. A method of controlling vehicle speed as in claim 45 wherein said fuel flow controller generally maintains a constant fuel flow rate relative to the fuel flow rate corresponding to the target set speed, wherein said system controller generates the command when vehicle speed approximates the upper set speed, or vehicle speed approximates the lower set speed.

49. A method of controlling vehicle speed as in claim 48 wherein the command is generated in response to the vehicle speed being proximate the lower set speed, the command comprising an instruction transmitted to said fuel controller to change fuel flow rate so as to attenuate loss of vehicle speed.

50. A method of controlling vehicle speed as in claim 48 wherein the command is generated in response to the vehicle speed being proximate the upper set speed, the command comprising an instruction transmitted to said fuel controller to change real time fuel flow rate so as to attenuate increase in vehicle speed.

51. A method of controlling vehicle speed as in claim 48 wherein the driver input includes a driver determined target set speed, said system controller providing at least one of an upper set speed and a lower set speed,
the cruise control system being adapted to receive and implement ongoing redefinition of the upper set speed, the lower set speed, and/or the target set speed while said vehicle cruise control system is in operation controlling speed of a vehicle.
